(19) United States
(12) Patent Application Publication
(10) Pub. No.: US 2024/0344217 A1
(43) Pub. Date: Oct. 17, 2024

(54) CARBON QUANTUM DOT WITH SINGLE TRANSITION METAL ELEMENT INTRODUCED, METHOD FOR MANUFACTURING THE SAME, AND ELECTROCHEMICAL CATALYST MANUFACTURED THEREBY

(71) Applicant: Research & Business Foundation SUNGKYUNKWAN UNIVERSITY, Suwon-si (KR)

(72) Inventors: Jung Kyu KIM, Suwon-si (KR); Unbeom BAECK, Suwon-si (KR); Seung Hun ROH, Suwon-si (KR)

(73) Assignee: Research & Business Foundation SUNGKYUNKWAN UNIVERSITY, Suwon-si (KR)

(21) Appl. No.: 18/632,883

(22) Filed: Apr. 11, 2024

(30) Foreign Application Priority Data
Apr. 11, 2023 (KR) 10-2023-0047356

(51) Int. Cl. C25B 11/075; B82Y 30/00; B82Y 40/00; C25B 11/065

(52) U.S. Cl. CPC C25B 11/075; C25B 11/065; B82Y 30/00; B82Y 40/00

(57) ABSTRACT

An embodiment of the present invention provides a catalyst with maximized activity and stability through synthesizing carbon quantum dots with transition metal elements introduced based on carbon compound monomers containing nitrogen elements that have excellent bonding ability with transition metals. By introducing low-cost transition metal atoms into nano carbon quantum dots (CQDs), a type of highly stable carbon nanostructure, the activity and stability of the hydrogen generation catalyst reaction through water electrolysis are simultaneously increased, so that an economical, highly active, highly stable catalyst for electrochemical hydrogen generation reaction can be manufactured.

### CROSS REFERENCE TO RELATED APPLICATION

The present application claims priority to Korean Patent Application No. 10-2023-0047356, filed Apr. 11, 2023, the entire contents of which is incorporated herein for all purposes by this reference.

### BACKGROUND OF THE INVENTION

### Field of the Invention

The present invention relates to the manufacturing of carbon quantum dots with single metal element introduced. More specifically, the present invention relates to a catalyst with maximized activity and stability by synthesizing carbon quantum dots into which a transition metal element is introduced based on a carbon compound monomer containing a nitrogen element with excellent bonding ability with a transition metal.

### Description of the Related Art

Hydrogen is one of the most abundant elements on Earth, and is attracting attention as an ideal resource as an energy carrier because it is highly sustainable and eco-friendly as it does not emit carbon during the energy production process.

This hydrogen is produced in a variety of ways, and among them, electrochemical water electrolysis technology is being studied as an eco-friendly technology in that it can produce hydrogen using water. A hydrogen generation catalyst, one of the components of the water electrolysis system, is one of the key factors that determines the efficiency of the system and is being actively researched.

However, catalysts with high efficiency are based on expensive precious metals such as platinum (Pt), palladium (Pd), and ruthenium (Ru), so they have limitations that make them difficult to commercialize. Also, precious metal-based hydrogen generation catalysts have the problem of low stability in acidic environments.

As a strategy to solve these problems, research is being conducted on using nanostructures based on transition metals and carbon, which are relatively abundant elements on Earth, as hydrogen generation catalysts. Transition metal-based hydrogen generation catalysts have the advantage of improved price competitiveness, but, like noble metal-based catalysts, they have the disadvantage of poor stability in various environments. Meanwhile, carbon-based nanostructures are attracting attention as hydrogen production catalysts due to their high stability and abundant functional groups, but they have the problem of low efficiency.

Therefore, there is a strong need to develop hydrogen generation catalyst materials that have high catalytic efficiency, maintain stability in various environments, and are economical.

### SUMMARY OF THE INVENTION

The technical object to be achieved by the present invention is to provide a method for manufacturing a metal single atom-carbon quantum dot electrochemical catalyst material that replaces existing noble metal catalysts and simultaneously secures catalytic activity and stability when applied as a hydrogen generation catalyst material.

The technical object to be achieved by the present invention is not limited to the technical object mentioned above, and other technical objects not mentioned may be clearly understood by those skilled in the art from the description below.

In order to achieve the above technical object, an embodiment of the present invention provides a carbon quantum dot with transition metal atom absorbed, comprising a carbon quantum dot support and a single transition metal atom introduced into the carbon quantum dot support.

In an embodiment of the present invention, the transition metal may be selected from Zn, Fe, Co, Ni and Ag.

In an embodiment of the present invention, a diameter of the carbon quantum dot support may be 5 nm or less.

In order to achieve the above technical object, another embodiment of the present invention provides a method for manufacturing a carbon quantum dot with transition metal atom adsorbed, comprising the steps of preparing a carbon precursor, mixing the carbon precursor and a transition metal precursor, and manufacturing a carbon quantum dot with transition metal atom adsorbed by hydrothermal synthesis of the mixed material.

In an embodiment of the present invention, the carbon precursor may be fumaronitrile.

In an embodiment of the present invention, the transition metal precursor may be a precursor selected from Zn, Fe, Co, Ni and Ag.

In an embodiment of the present invention, a diameter of the carbon quantum dot may be 5 nm or less.

In order to achieve the above technical object, another embodiment of the present invention provides an electrochemical catalyst based on an electrode comprising a carbon quantum dot with transition metal atom adsorbed, which is manufactured according to the above manufacturing method.

### BRIEF DESCRIPTION OF THE DRAWINGS

FIG. 1A shows a schematic diagram of a synthesis method and atomic structure of metal-doped carbon quantum dot (M@CQD) through a hydrothermal synthesis process of a fumaronitrile and metal precursor, FIG. 1B shows transmission electron micrographs and quantum dot size distributions of M@CQD material at 20 nm, FIG. 1C shows transmission electron micrographs and quantum dot size distributions of M@CQD material at 20 nm, FIG. 1D shows transmission electron micrographs and quantum dot size distributions of M@CQD material at 2 nm, and FIG. 1E shows a graph of element ratio analysis results obtained from X-ray photoelectron spectroscopy spectra of M@CQD materials.

FIG. 2 shows an energy dispersive spectral element distribution spectrum of Ni@CQD.

FIG. 3A shows a number of carbon quantum dots, FIG. 3B shows the interlattice distance of the corresponding carbon quantum dots, FIG. 3C shows graph that the y-axis represents the frequency and the number of carbon quantum dots and the x-axis represents the diameter of the quantum dot, FIG. 3D shows a number of carbon quantum dots, FIG. 3E shows the interlattice distance of the corresponding carbon quantum dots, FIG. 3F shows graph that the y-axis represents the frequency and the number of carbon quantum dots and the x-axis represents the diameter of the quantum dot.

FIG. 4A shows X-ray photoelectron spectroscopy spectra of Ni@CQD material and CQD material with respect to Ni, FIG. 4B shows X-ray photoelectron spectroscopy spectra of Ni@CQD material and CQD material with respect to C, FIG. 4C shows X-ray photoelectron spectroscopy spectra of Ni@CQD material and CQD material with respect to N, FIG. 4D shows Fourier transform infrared spectral spectra of M@CQD material and CQD material, FIG. 4E shows ultraviolet-visible spectral spectra of M@CQD material and CQD material, FIG. 4F shows photoluminescence spectrum of Ni@CQD material.

FIG. 5A shows a polarization curve in a hydrogen evolution reaction (HER) of M@CQD materials, FIG. 5B shows Tafel diagram based on the HER polarization curve, FIG. 5C shows comparison of overvoltage required to achieve current density values of 10 and 100 mA cm-2 compared to reversible hydrogen electrode for M@CQD materials, FIG. 5D shows electrochemical impedance Nyquist diagram of M@CQD catalysts, and FIG. 5E shows a polarization curve graph of Ni@CQD catalyst before and after 1000 electrochemical experiments.

FIG. 6A shows XAFS data of carbon quantum dots into which a transition metal single atom is introduced, FIG. 6B shows the peak range between 0 and 5 Å, FIG. 6C shows the peak range between 1.4 and 1.9 Å.

FIG. 7 shows a TEM image of carbon particles including a high molar ratio of metal precursors, FIG. 7A shows a number of carbon quantum dots, FIG. 7B shows the interlattice distance of the corresponding carbon quantum dots, FIG. 7C shows graph that the y-axis represents the frequency and the number of carbon quantum dots and the x-axis represents the diameter of the quantum dot, FIG. 7D shows a number of carbon quantum dots, FIG. 7E shows the interlattice distance of the corresponding carbon quantum dots, FIG. 7F shows graph that the y-axis represents the frequency and the number of carbon quantum dots and the x-axis represents the diameter of the quantum dot.

### DETAILED DESCRIPTION OF THE INVENTION

Hereinafter, the present invention will be explained with reference to the accompanying drawings. The present invention, however, may be modified in various different ways, and should not be construed as limited to the embodiments set forth herein. Also, in order to clearly explain the present invention, portions that are not related to the present invention are omitted, and like reference numerals are used to refer to like elements throughout.

Throughout the specification, it will be understood that when an element is referred to as being “connected (accessed, contacted, coupled) to” another element, this includes not only cases where the elements are “directly connected,” but also cases where the elements are “indirectly connected” with another member therebetween. Also, it will also be understood that when a component “includes” an element, unless stated otherwise, this does not mean that other elements are excluded, but that other element may be further added.

The terms used herein are only used to describe specific embodiments and are not intended to limit the present invention. The singular forms are intended to include the plural forms as well, unless the context clearly indicates otherwise. In the specification, it will be further understood that the terms “comprise” and “include” specify the presence of stated features, integers, steps, operations, elements, components, or combinations thereof, but do not preclude in advance the possibility of the presence or addition of one or more other features, integers, steps, operations, elements, components, or combinations.

Hereinafter, embodiments of the present invention will be described in detail with reference to the accompanying drawings.

Terms used in the present specification are defined as follows.

“CQD” refers to carbon quantum dot.

“M@CQD” refers to carbon quantum dot doped with metal.

“Ni@CQD” refers to carbon quantum dot doped with nickel (Ni).

A carbon quantum dot to which a transition metal atom is absorbed according to an embodiment of the present invention will be described.

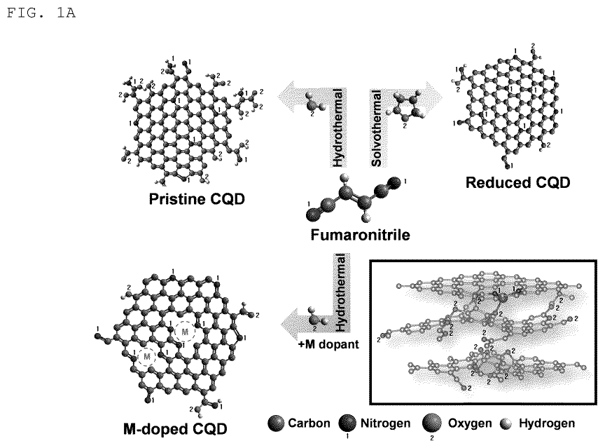

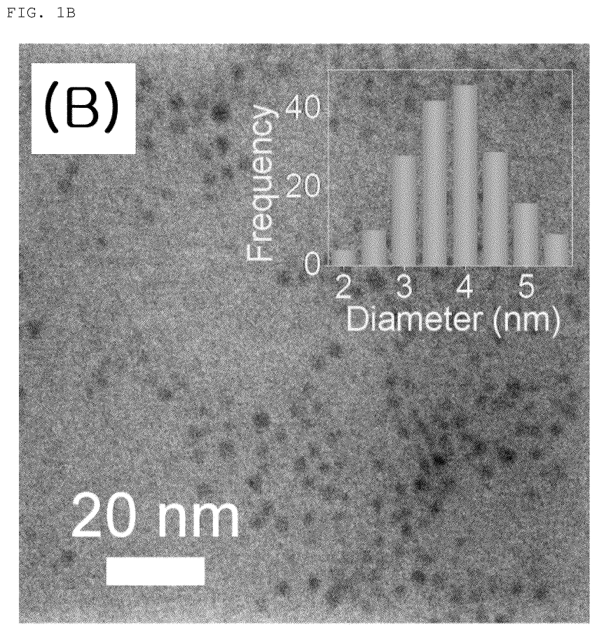

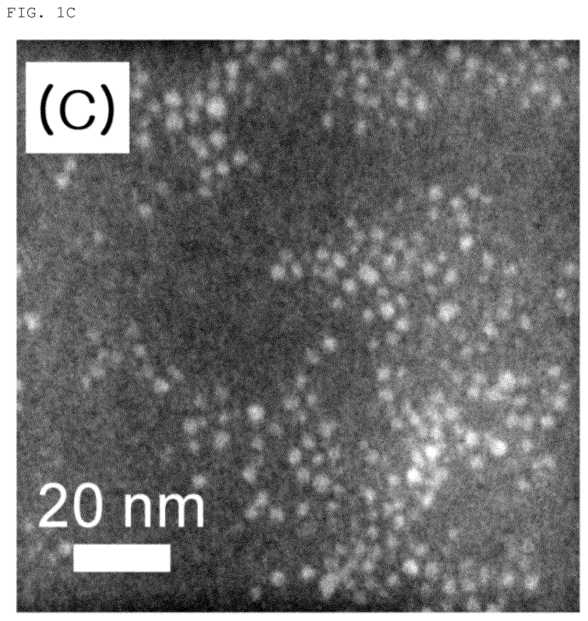

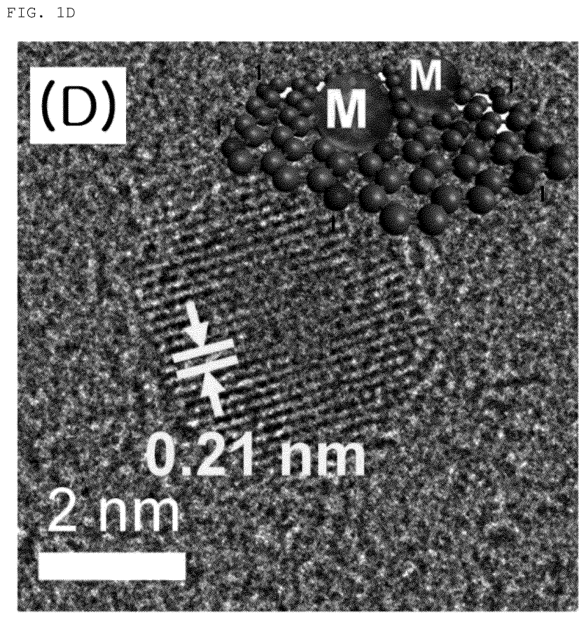

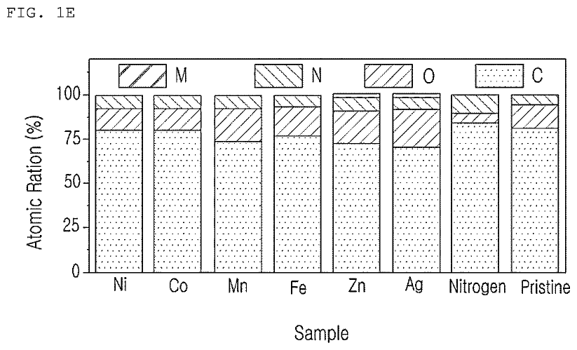

FIG. 1(A) is a schematic diagram of a synthesis method and atomic structure of metal-doped carbon quantum dot (M@CQD) through a hydrothermal synthesis process of fumaronitrile and a metal precursor.

Referring to FIG. 1(A), a carbon quantum dot with transition metal element adsorbed according to an embodiment of the present invention may comprise a carbon quantum dot support and a single transition metal atom introduced into the carbon quantum dot support.

Unlike conventional carbon materials, carbon quantum dots are used as a basic support. By using carbon quantum dots as the basic support and introducing transition metals as atoms, it is possible to develop materials that can provide excellent performance while minimizing the amount of transition metals used.

The transition metal may be selected from Zn, Fe, Co, Ni, and Ag.

The diameter of the carbon quantum dot support may be 5 nm or less. The carbon quantum dot support exhibits different optical properties depending on its diameter due to the quantum confinement effect. The smaller the diameter, the more intense light in the ultraviolet range can be absorbed. For this purpose, a quantum dot support of 5 nm or less that can have a large surface area is synthesized.

Hereinafter, a method for manufacturing a carbon quantum dot transition metal atom absorbed according to another embodiment of the present invention will be described.

The present invention provides a method for manufacturing a carbon quantum dot (M@CQD) with a single metal atom introduced, which complements the shortcomings of carbon nanostructures as a water electrolysis hydrogen generation catalyst material.

A method for manufacturing a carbon quantum dot with transition metal atom adsorbed, according to an embodiment of the present invention may comprise the steps of preparing a carbon precursor, mixing the carbon precursor and a transition metal precursor, and manufacturing a carbon quantum dot with transition metal atom adsorbed by hydrothermal synthesis of the mixed material.

The first step is to prepare a carbon precursor. The carbon precursor may be fumaronitrile. Fumaronitrile is a carbon compound containing a nitrogen element, and metal atom deposition may occur due to the bonding of carbon and nitrogen due to the introduction of a transition metal atom.

Next is the step of mixing the carbon precursor and a transition metal precursor. The transition metal precursor may be a precursor selected from Zn, Fe, Co, Ni, and Ag. The carbon precursor and transition metal precursor are mixed and immersed in a water bath containing preheated silicone oil to prepare for the hydrothermal synthesis step. If the amount of transition metal precursor increases, there is a possibility that it will become a transition metal oxide rather than a carbon quantum dot with a single atom introduced.

The last step is to prepare the carbon quantum dot with transition metal atom adsorbed by hydrothermal synthesis of the mixed materials. Hydrothermal synthesis is a method for crystallizing materials from high temperature aqueous solutions at high atmospheric pressure. After hydrothermal synthesis is completed, it is cooled in cold water, stirred with distilled water, and by-products are removed. The diameter of the carbon quantum dot may be 5 nm or less.

In the hydrothermal synthesis step, water or an organic solvent may be used as a solvent. Referring further to FIG. 1(A), in case of water solvent basis, a pristine CQD structure is produced according to the blue arrow (hydrothermal). In case of organic solvent basis, CQDs are produced according to the gray arrow (solvothermal), but the carbon atom defects present in pristine CQDs are not produced in case of organic solvent basis, so a simple (reduced) CQD is produced. Specifically, in the case of CQDs synthesized in an aqueous solution, the clear meaning of the above reduced is the (oxidized) CQDs with oxides present in a surface functional group. In the case of reduced CQDs, since they are CQDs synthesized in an organic solvent, they refer to relatively reduced CQDs with minimal oxide functional groups on the carbon quantum dots.

In order to manufacture M@CQDs by introducing metal atoms into CQDs, in the case of reduced CQDs, there is not enough space (site) for metal atoms to be introduced, so atomic defects are intentionally induced based on a water solvent and metal atoms may be introduced after creating a space (site) into which metal atoms may be introduced.

Hereinafter, an electrochemical catalyst according to another embodiment of the present invention will be described.

The electrochemical catalyst according to an embodiment of the present invention may be based on an electrode comprising the carbon quantum dot with transition metal atom adsorbed, which is manufactured according to the manufacturing method.

By introducing low-cost transition metal atoms into nano carbon quantum dots, a type of highly stable carbon nanostructure, the activity and stability of the hydrogen generation catalyst reaction through water electrolysis are simultaneously increased, so that an economical, highly active, highly stable catalyst for electrochemical hydrogen generation reaction can be manufactured.

By maximizing the catalytic active point and catalytic reaction kinetics, it is possible to develop an economical catalyst for hydrogen generation with high activity with a minimum metal ratio, and the excellent stability of carbon quantum dots due to numerous covalent bonds can ensure long-term stability of the material due to catalytic reactions.

Hereinafter, M@CQD and M@CQD-based water electrolysis hydrogen generation catalyst and experimental examples according to the preparation example of the present invention will be described.

### Preparation Example 1: Ni@CQD

0.21 g of silver nitrate or 0.22 g of nickel acetate was dissolved in 100 ml of distilled water. 3 ml of this aqueous solution was stirred (150 rpm) with 300 mg of fumaronitrile for 30 minutes. The solution obtained through stirring was placed in a Teflon liner and then placed in a high-pressure sterilizer (autoclave) and then assembled. The assembled autoclave device was immersed in a water bath containing silicone oil preheated to 200° C. Hydrothermal synthesis was performed in a silicone oil bath while stirring at 150 rpm for 20 minutes. After the hydrothermal synthesis method was completed, the high-pressure sterilization device was cooled in cold water for 15 minutes. After cooling was completed, the assembled high-pressure sterilization device was dismantled, the Teflon liner was opened, and an additional 9 ml of distilled water was added. Thereafter, stirring was carried out at 400 rpm for 5 minutes using a stirrer. After the stirring was completed, the obtained solution was filtered through a PTFE membrane, then sufficiently dispersed using distilled water and ethanol as solvents, and then washed through centrifugation several times to remove residual salt by-products.

### Preparation Example 2: Ni@CQD-Based Water Electrolysis Hydrogen Generation Catalyst

To manufacture a water electrolysis hydrogen generation catalyst with the Ni@CQD prepared in Preparation Example 1, 4 mg of carbon quantum dot catalyst, 0.5 mg of 3D rGO serving as a conductive material, and 15 μL of Nafion solution were added to 1 mL of water/ethanol mixed solution (1:1 volume ratio) and then mixed using an ultrasonic disperser for 30 minutes. 7.5 μL of the prepared solution was sprinkled on a nickel foam electrode and stored in a vacuum oven for more than 12 hours to be dried. The electrode manufactured in this way is used as a water electrolysis hydrogen generation catalyst.

### Experimental Example 1: Confirmation of Metal Single Atom Introduction Using a Microscope

High-resolution transmission electron microscope (HR-TEM) and energy dispersive spectroscopy elemental mapping (EDS elemental mapping) were used to confirm whether several nanometer-sized carbon quantum dots with metal single atoms introduced were synthesized through hydrothermal synthesis.

FIGS. 1(B) to (D) are transmission electron micrographs and quantum dot size distribution diagrams of the M@CQD material. Referring to FIGS. 1(B) to (D), it can be seen that M@CQDs at the 3 to 4 nm level were synthesized.

FIG. 1(E) is a graph of the element ratio analysis results obtained from the X-ray photoelectron spectroscopy spectrum of M@CQD materials. Referring to FIG. 1(E), the value of M, which means the transition metal element ratio, exists at a very small ratio, confirming that the transition metals were introduced at the single atom level rather than in large quantities.

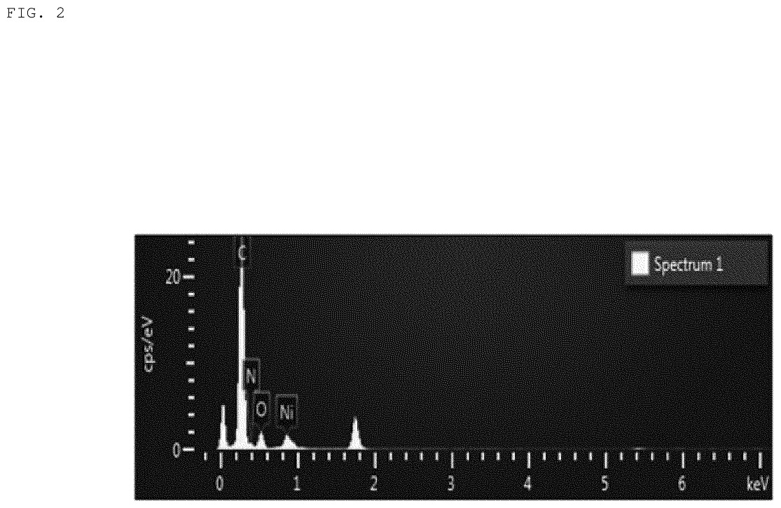

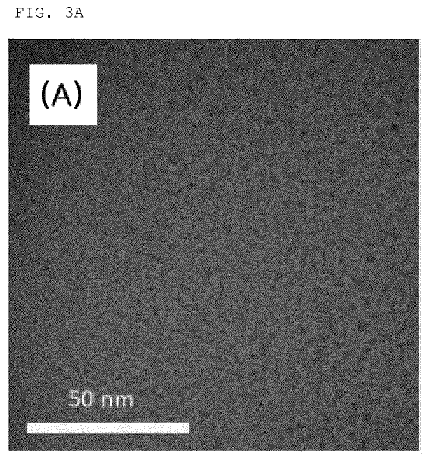

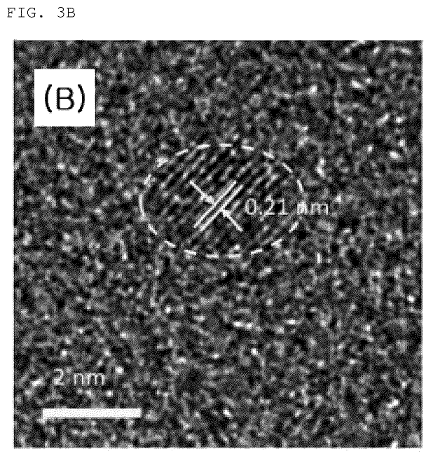

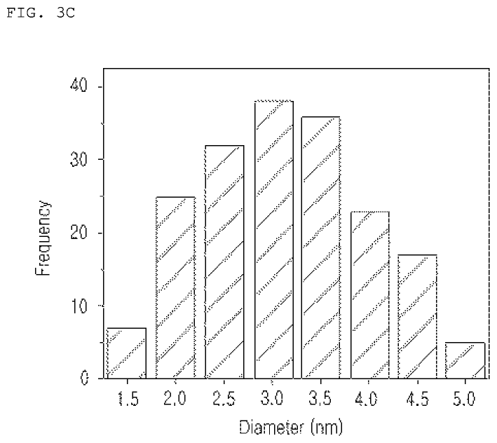

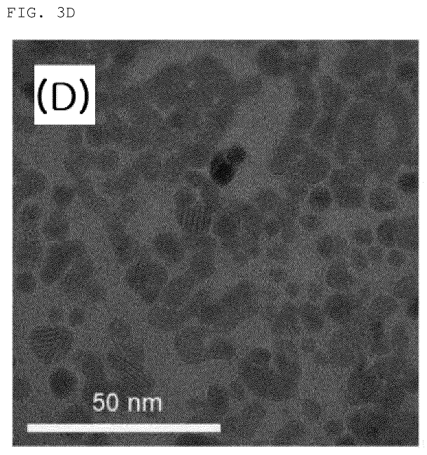

FIG. 2 is an energy dispersion spectral element distribution spectrum of Ni@CQD, and Table 1 is a table for each element.

TABLE 1

| Element | Wt % | Atomic % |
|---|---|---|
| C | 91.70 | 94.96 |
| N | 1.01 | 0.89 |
| O | 4.60 | 3.57 |
| Ni | 2.70 | 0.57 |
| Total: | 100.00 | 100.00 |

Referring to FIG. 2 and Table 1, it can be seen that a small amount of nickel atoms were introduced into the carbon quantum dots.

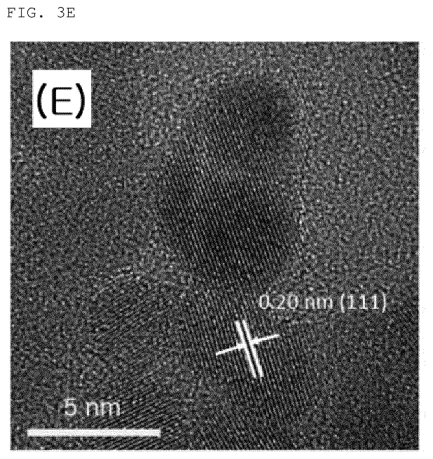

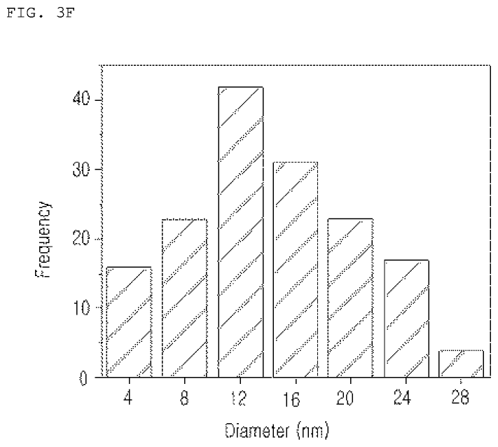

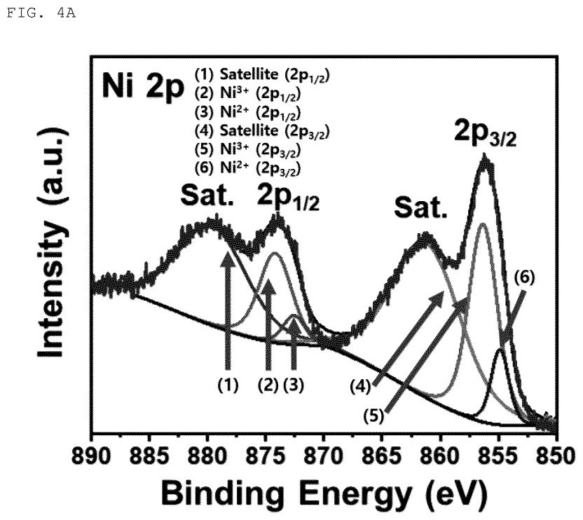

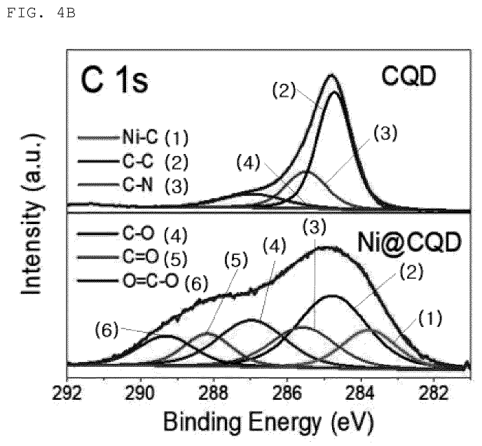

FIG. 3 is a TEM image of a product according to a metal precursor content. Referring to FIG. 3, a number of carbon quantum dots can be confirmed through FIG. 3(A) and FIG. 3(D), and the interlattice distance of the corresponding carbon quantum dots can be confirmed through FIG. 3(B) and FIG. 3(E). Through FIG. 3(C) and FIG. 3(F), the y-axis represents the frequency and the number of carbon quantum dots, and the x-axis represents the diameter of the quantum dot. The size (diameter) of the most dominant quantum dot can be confirmed through the number of quantum dots with the corresponding diameter.

In the case of a product in which the content of the metal precursor is increased to 20%, the size of the metal oxide is more than 4 times larger than the average size of 3 nanometers, which is the average size of carbon quantum dots. It can be seen that as the content of the metal precursor increases, a metal oxide form is generated rather than a single atom being introduced into the carbon quantum dot.

### Experimental Example 2: Confirmation of Metal Single Atom Introduction Through Optical and Electrical Analysis

To confirm that a single metal atom was introduced into the carbon quantum dots, an analysis was conducted through X-ray photoelectron spectroscopy (XPS), Fourier-transform infrared spectroscopy (FT-IR), ultraviolet-visible spectroscopy (UV-Vis), and photoluminescence spectroscopy (PL).

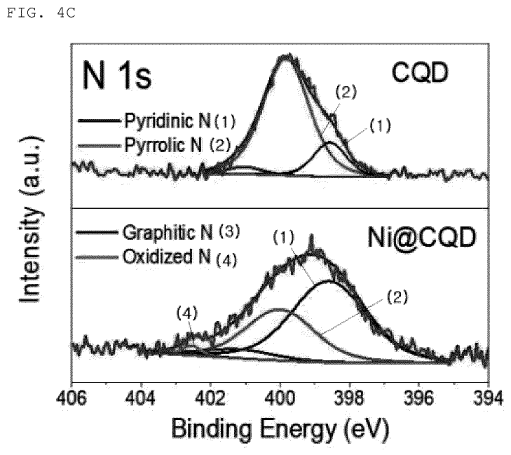

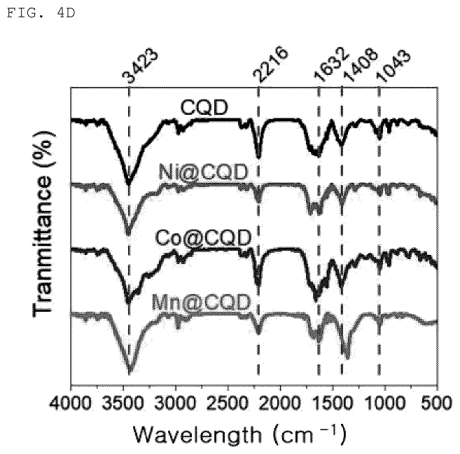

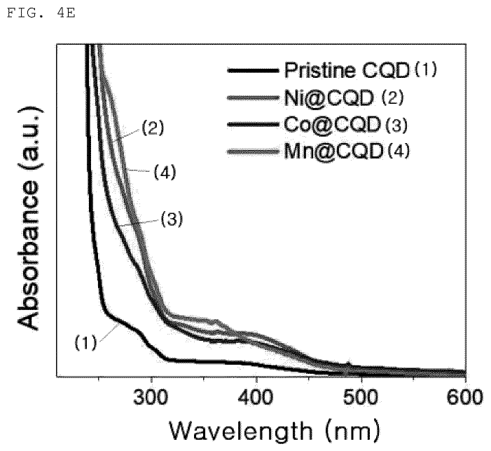

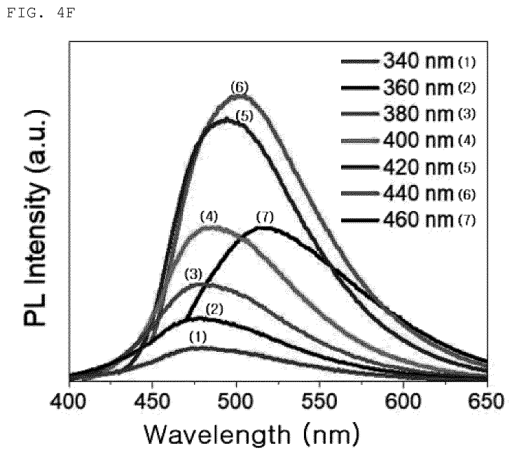

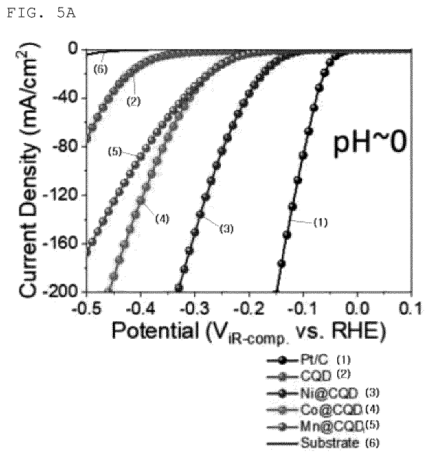

FIG. 4 shows X-ray photoelectron spectroscopy spectra of Ni@CQD material and CQD material with respect to (A) Ni, (B) C, (C) N, (D) Fourier transform infrared spectral spectra of M@CQD material and CQD material, (E) ultraviolet-visible spectral spectra of M@CQD material and CQD material, (F) photoluminescence spectrum of Ni@CQD material.

Referring to FIGS. 4(A) to (C), it can be confirmed through X-ray photoelectron spectroscopy (XPS) that nickel, a single metal atom, was introduced into the carbon quantum dots.

In FIG. 4(A), peaks (1) and (4) represent interactions occurring simultaneously with the outermost electrons during the process of core electron emission induced by the X-ray source in XPS measurements. These peaks are not significantly analyzed in this invention. While they may provide meaningful information, they are generally considered noise resulting from the measurement process.

Peaks (2) and (5), as well as (3) and (6), correspond to peaks for nickel with oxidation states of 3+/2+, wherein metallic peaks of non-oxidized nickel (Ni0) are not observed. This suggests that nickel is bound to carbon/nitrogen-based quantum dots.

Fumaronitrile is a precursor that has two nitrogen-carbon triple bonds, and carbon quantum dots using the corresponding precursor are bottom-up materials that grow by breaking a bond between nitrogen and carbon and forming a covalent bond with adjacent fumaronitrile. When a transition metal precursor such as nickel is added to an aqueous solution of fumaronitrile, the lone pair of electrons of nitrogen and the transition metal precursor with positive ions exist in a strong interaction. Then, when hydrothermal synthesis is performed under the same conditions as before, carbon quantum dots comprising a single-atom level transition metal are synthesized due to the strong bonding force between nitrogen and transition metal. The nitrogen in the resulting product of the synthesis process is observed regardless of whether the transition metal is introduced through X-ray photoelectron spectroscopy (XPS) analysis. However, when the transition metal is introduced, the proportion of pyridinic nitrogen is confirmed to increase, and thus the indirect bond between nitrogen and transition metal inside the carbon quantum dot by bonding with the transition metal can be confirmed and the atomic arrangement can be expected.

Referring to FIG. 4(D), changes in the chemical bond of carbon quantum dots into which metal atoms are introduced as revealed through X-ray photoelectron spectroscopy can be confirmed through Fourier-transform infrared spectroscopy (FT-IR).

Referring to FIG. 4(E), through ultraviolet-visible spectroscopy (UV-Vis), it can be confirmed that the light absorption intensity increases as the single metal atom is introduced, and that this is an effect due to the bond between carbon and nitrogen following the introduction of the metal atom.

Referring to FIG. 4(F), photoluminescence spectroscopy (PL) shows light emission in the 340 to 360 nm region, and it can be confirmed that the photoelectric characteristics are due to the quantum confinement effect of Ni@CQD at the several nm level, and that it is consistent with the microscopic photo results.

### Experimental Example 3: Confirmation of Electrochemical Water Reduction Performance

The water reduction reaction performance of electro-catalytic (EC) M@CQD was confirmed by measurement in 0.5 M sulfuric acid electrolyte using a potentiostat.

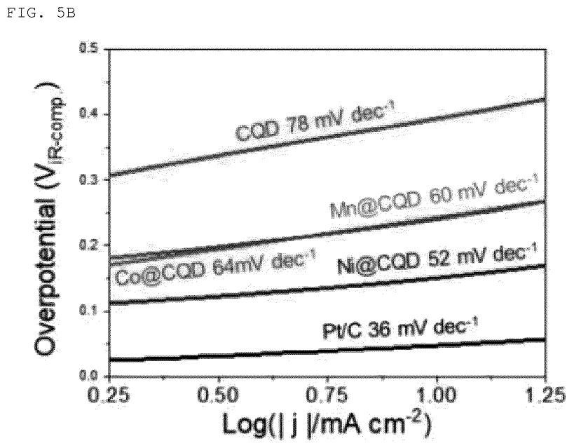

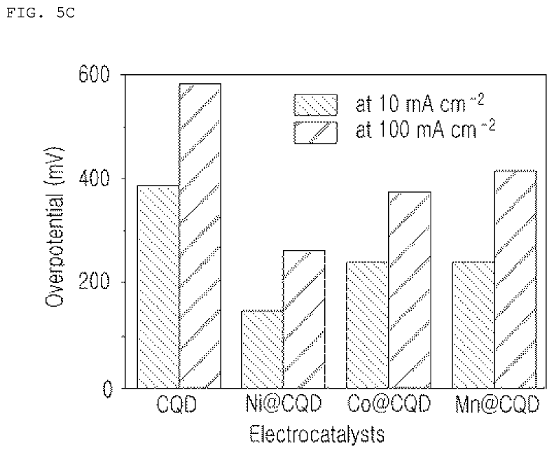

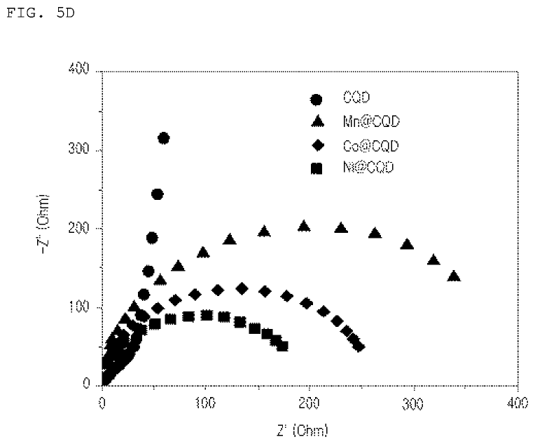

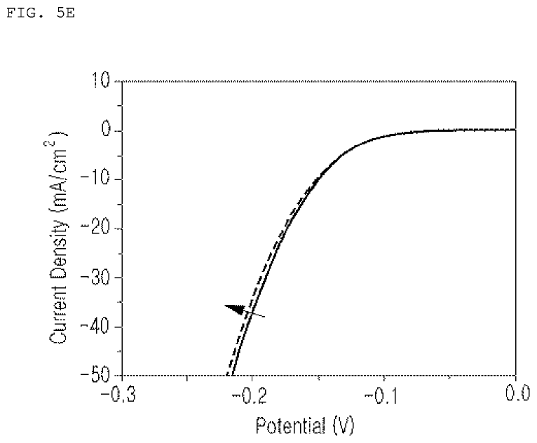

FIG. 5 shows (A) a polarization curve in a hydrogen evolution reaction (HER) of M@CQD materials, (B) Tafel diagram based on the HER polarization curve, (C) comparison of overvoltage required to achieve current density values of 10 and 100 mA cm⁻² compared to reversible hydrogen electrode for M@CQD materials, (D) electrochemical impedance Nyquist diagram of M@CQD catalysts, (E) electrochemical double layer capacitance measurement results of Ni@CQD material derived from CV curves at various scanning speeds, and (F) a polarization curve graph of Ni@CQD catalyst before and after 1000 electrochemical experiments.

Referring to FIG. 5(A), when an experiment on the hydrogen generation reaction in a strong acid was conducted and a comparison was made using pt/C, the electric hydrogen generation catalyst material known to have the best performance to date, as a reference, in the case of existing CQD graphs, even when a strong reduction voltage is applied, the corresponding current amount is insufficient, but when metals such as nickel (Ni), cobalt (Co), and manganese (Mn) are introduced, a better current is generated compared to the same voltage. The fact that this current is high indicates that an excellent hydrogen generation catalyst material has been developed.

Specifically, the overvoltage required for the carbon quantum dot (Ni@CQD)-based electrode with nickel single atoms introduced to reach a current density of 10 mA/cm² is 189 mV, which shows superior performance compared to the required overvoltage of 390 mV for a carbon quantum dot-based electrode without metal introduction.

Referring to FIG. 5(B), using the slope of the Tafel diagram, the lower the slope, the better the performance. The Pt/C line has the lowest slope, and the CQD is 78 mV dec-1. Thus, when nickel, manganese, and cobalt are introduced, the slope decreases in the case of Ni@CQD, Mn@CQD, and Co@CQD. Further, as the slope of the Tafel diagram decreases after the introduction of metal single atoms, it can be confirmed that metal atoms mainly contributed to the catalytic activity.

Referring to FIG. 5(C), as one of the indicators to evaluate catalyst performance, the voltages required when a specific current value is generated are compared and analyzed. When comparing the voltages required to generate a current of 10 mA cm-2 and current of 100 mA cm-2, the voltages are 400 mV for 10 mA cm-2 and about 600 mV for 100 mA cm-2 for CQDs. When nickel, cobalt, and manganese are introduced, the required voltage is lowered, and especially when nickel is introduced, the lowest overvoltage is required. Therefore, it can be confirmed that when nickel is introduced, sufficient current can be generated even with a lower voltage, showing excellent catalytic performance.

Referring to FIG. 5(D), through electrochemical impedance spectroscopy (EIS) of the Nyquist plot, the smaller the size of the semicircular shape, the smaller the resistance inside the material electrode. Compared to the case of CQD, when manganese, cobalt, and nickel are introduced, the size of the semicircular shape is small and the resistance inside the material electrode is less, so charge transfer is easy, and it can be seen that the catalytic properties are improved through single metal atoms. Specifically, it can be seen that when nickel is introduced, the resistance is the lowest, so internal charge transfer is the easiest, showing excellent catalytic properties.

Referring to FIG. 5(E), the catalyst performance remained similar even after 1000 electrochemical water reduction reactions, confirming the stability of the M@CQD-based water electrolysis hydrogen generation catalyst.

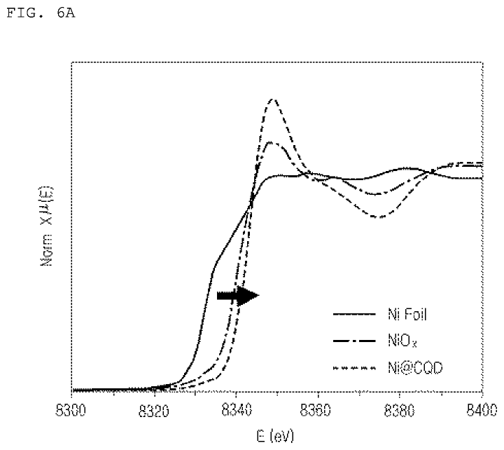

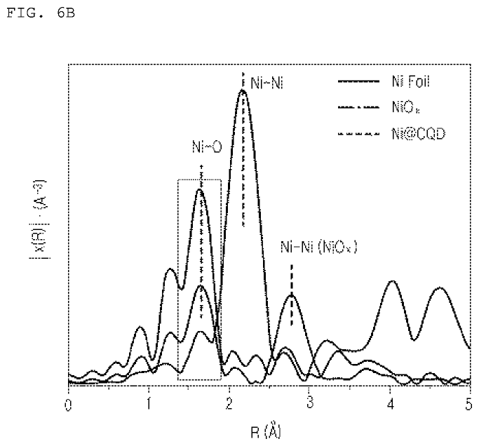

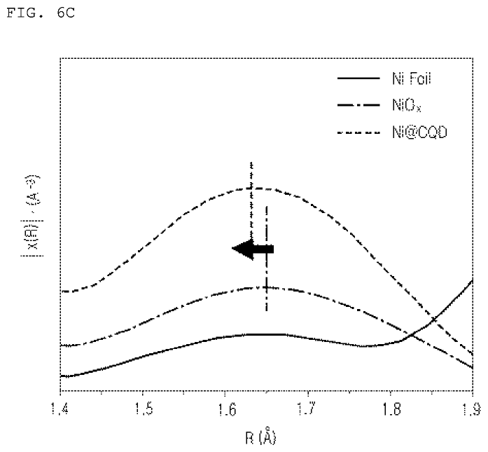

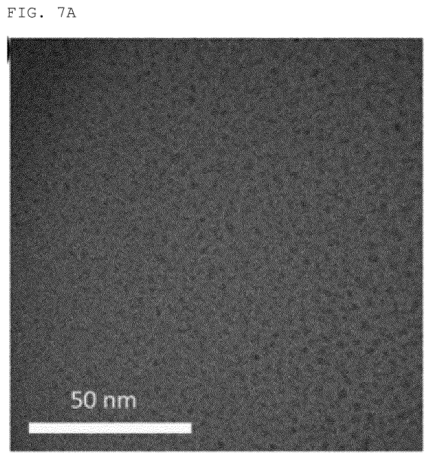

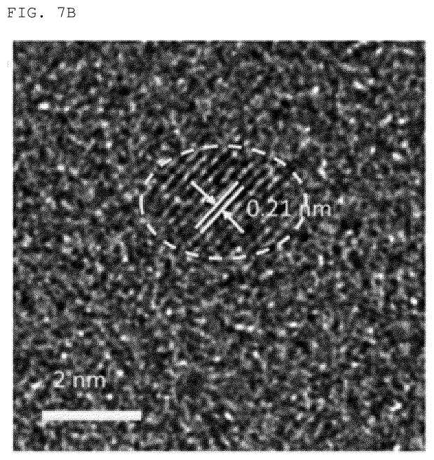

FIG. 6 shows XAFS data of carbon quantum dots into which a transition metal single atom is introduced. Although the bond between the transition metal and nitrogen was confirmed through XPS data, it cannot be directly confirmed that the transition metal was introduced into the carbon quantum dot at the single atom level. To solve this problem, microanalysis of transition metals was performed using X-ray absorption fine structure (XAFS). As a result, the peak corresponding to 2.18 Å was not observed, confirming that the Ni—Ni bond, which indicates a bond between transition metals, did not exist in the corresponding material (meaning that the nickel in the corresponding material was not a metal particle). When compared with a comparison group, transition metal oxide (NiOx), it was confirmed that the interaction peak (2.77 Å) between transition metals in the transition metal oxide observed in the comparison group was not observed in the corresponding material (the corresponding peak indicates the interaction between adjacent nickels when nickel oxide has a crystal structure. Since there was no corresponding peak, it can be confirmed that in the present invention, the transition metal was introduced into the carbon quantum dot at the single atom level. If present, it means that several to tens of nm of nickel oxide was introduced into the carbon quantum dots). Additionally, it was confirmed that the peak (1.65 Å) observed due to the bonding of transition metal and oxygen decreased (1.63 Å), which means that the carbon quantum dots into which the transition metal single atom was introduced were not introduced into the quantum dots only through a bond with oxygen without bonding with nitrogen, but were introduced into the quantum dots through a bond with nitrogen/oxygen (since the transition metal-nitrogen bond is generally located at 1.4 Å, the bond with nitrogen was identified by moving in the corresponding direction).

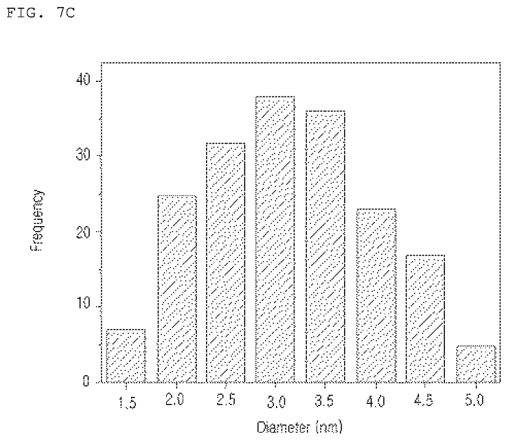

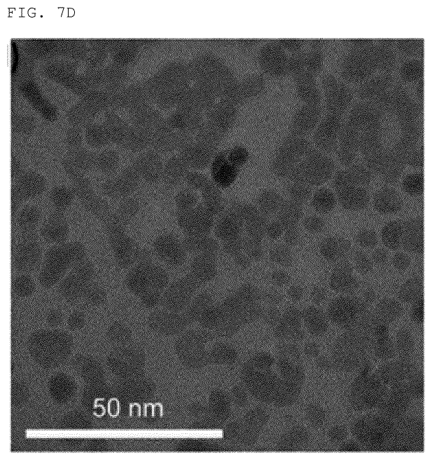

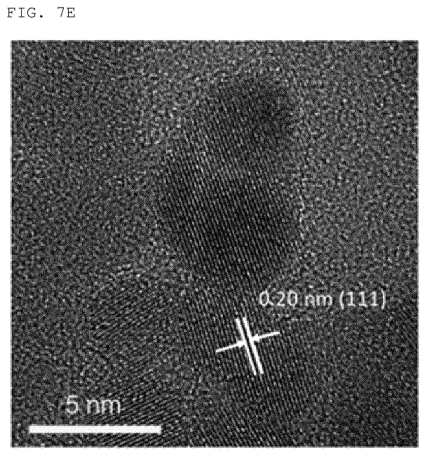

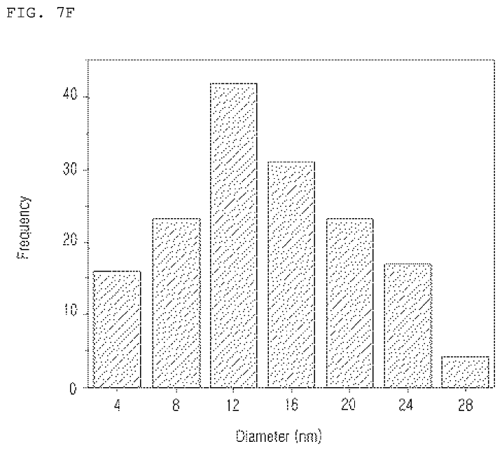

FIG. 7 shows a TEM image of carbon particles including a high molar ratio of metal precursors. The ratio of transition metal and fumaronitrile was designed through experiment with a bonding structure that can be expected upon introduction of an ideal single-atom level transition metal and a precursor ratio (3 mol %, ratio of fumaronitrile to metal precursor) based on this. To confirm the feasibility of the corresponding design, synthesis was performed with an excessive amount of transition metal (20 mol %), and as a result, the production of transition metal hydroxide (Nickel hydroxide) and the overall particle size distribution also increased to the tens of nm level. This is a result that does not correspond to the synthesis of quantum dots of less than 5 nm and the introduction of single atoms of transition metals, which are expected by the present invention.

In conclusion, carbon quantum dots into which a transition metal element introduced are synthesized through a single hydrothermal synthesis based on a carbon compound monomer containing a nitrogen element that has excellent bonding ability with a transition metal, and through this, it is possible to manufacture catalyst materials with maximized catalytic activity and stability.

By introducing low-cost transition metal atoms into nano carbon quantum dots (CQDs), a type of highly stable carbon nanostructure, the activity and stability of the hydrogen generation catalyst reaction through water electrolysis are simultaneously increased, so that an economical, highly active, highly stable catalyst for electrochemical hydrogen generation reaction can be manufactured.

The description of the present invention is used for illustration and those skilled in the art will understand that the present invention can be easily modified to other detailed forms without changing the technical spirit or an essential feature thereof. Therefore, the aforementioned exemplary embodiments are all illustrative in all aspects and are not limited. For example, each component described as a single type may be implemented to be distributed and similarly, components described to be distributed may also be implemented in a combined form.

The scope of the invention is to be defined by the scope of claims provided below, and all variations or modifications that can be derived from the meaning and scope of the claims as well as their equivalents are to be interpreted as being encompassed within the scope of the present invention.

According to an embodiment of the present invention, carbon quantum dots into which a transition metal element is introduced are synthesized through a single hydrothermal synthesis based on a carbon compound monomer containing a nitrogen element that has excellent bonding ability with a transition metal, and through this, it is possible to manufacture catalyst materials with maximized catalytic activity and stability.

By introducing low-cost transition metal atoms into nano carbon quantum dots (CQDs), a type of highly stable carbon nanostructure, the activity and stability of the hydrogen generation catalyst reaction through water electrolysis are simultaneously increased, so that an economical, highly active, highly stable catalyst for electrochemical hydrogen generation reaction can be manufactured.

The effects of the present invention are not limited to the above-mentioned effects, and it should be understood that the effects of the present invention include all effects that could be inferred from the configuration of the invention described in the detailed description of the present invention or the appended claims.

What is claimed is:

1. A carbon quantum dot with transition metal atom adsorbed, comprising:
a carbon quantum dot support; and
a single transition metal atom introduced into the carbon quantum dot support.

2. The carbon quantum dot of claim 1, wherein the transition metal is selected from Zn, Fe, Co, Ni and Ag.

3. The carbon quantum dot of claim 1, wherein a diameter of the carbon quantum dot support is 5 nm or less.

4. A method for manufacturing a carbon quantum dot with transition metal atom adsorbed, comprising the steps of:
preparing a carbon precursor;
mixing the carbon precursor and a transition metal precursor; and
manufacturing a carbon quantum dot with transition metal atom adsorbed by hydrothermal synthesis of the mixed material.

5. The method of claim 4, wherein the carbon precursor is fumaronitrile.

6. The method of claim 4, wherein the transition metal precursor is a precursor selected from Zn, Fe, Co, Ni and Ag.

7. The method of claim 4, wherein a diameter of the carbon quantum dot is 5 nm or less.

8. An electrochemical catalyst based on an electrode comprising a carbon quantum dot with transition metal atom adsorbed, which is manufactured according to the method of claim 4.

9. A water electrolysis electrode comprising the electrochemical catalyst of claim 8.

10. A water electrolysis device comprising the water electrolysis electrode of claim 9.
